(19) United States
(12) Patent Application Publication
(10) Pub. No.: US 2014/0142802 A1
(43) Pub. Date: May 22, 2014

(54) VEHICLE DATA PROCESSING DEVICE AND VEHICLE DATA PROCESSING METHOD THEREOF

(71) Applicant: INSTITUTE FOR INFORMATION INDUSTRY, Taipei (TW)

(72) Inventor: Jyun-Naih LIN, Taipei City (TW)

(73) Assignee: INSTITUTE FOR INFORMATION INDUSTRY, Taipei (TW)

(21) Appl. No.: 13/708,882

(22) Filed: Dec. 7, 2012

(30) Foreign Application Priority Data
Nov. 21, 2012 (TW) 101143502

(51) Int. Cl. G06F 19/00

(52) U.S. Cl. CPC G06F 19/00
USPC 701/33.2

(57) ABSTRACT

A vehicle data processing device and a vehicle data processing method thereof are provided. The vehicle data processing device gets vehicle data items of a vehicle and creates a vehicle data menu according to the vehicle data items. The vehicle data processing device transmits a different inquiry packet to the vehicle according to the vehicle data menu at a query time interval. The vehicle data processing device receives a plurality of reply packets from the vehicle, wherein each of the reply packets corresponds to each of the inquiry packets. The vehicle data processing device analyses the reply packets to generate a plurality of readable vehicle data of the vehicle, and stores the readable vehicle data. The vehicle data processing device supplies the vehicle data menu to user terminals and processes the vehicle data queries from the user terminals to provide the readable vehicle data thereto.

### PRIORITY

This application claims priority to Taiwan Patent Application No. 101143502, filed on Nov. 21, 2012, which is hereby incorporated by reference in its entirety herein.

### FIELD

The present invention relates to a vehicle data processing device and a vehicle data processing method thereof. More particularly, the present invention relates to a vehicle data processing device capable of retrieving and analyzing vehicle data in advance and a vehicle data processing method thereof.

### BACKGROUND

The On-board Diagnostics (OBD) protocol or the OBD2 protocol (collectively termed as the OBD-series protocols hereinafter) is a kind of communication protocol that can alert a driver to a failure of a vehicle and provide standardized information codes of vehicle data in a specific manner, which allow one to rapidly inspect and fix malfunctions as the vehicle is repaired. Therefore, many countries have specified that vehicles manufactured shall conform to the OBD-series protocols so that communication and data transmission can be carried out between user terminals and the vehicles according to the OBD-series protocols.

The original purpose of formulating the OBD-series protocols is to allow a vehicle and a maintainer to communicate with each other when the vehicle is sent back to the factory for repair. Due to the limited bandwidth between the user terminal and the vehicle, the OBD-series protocols specify that, when the user terminal inquires the vehicle data from an electronic control unit (ECU) of the vehicle, question-and-answers can only be made one by one. Therefore, when the maintainer is to obtain various vehicle data, he cannot obtain the various vehicle data simultaneously but can only inquire the various vehicle data from the ECU of the vehicle one by one to obtain the various vehicle data in sequence. Apart from repairing in factories, some vehicle application services begin to utilize various real-time vehicle data to provide the driver with safer services currently.

Additionally, although the user terminal can obtain standardized information codes of vehicle data from the vehicle according to the OBD-series protocols, the user terminal is unable to know the values or meanings represented by the information codes straightforwardly before the information codes are analyzed. Currently, there are primarily two ways of analyzing the information codes, one is to utilize an additional analyzing device or programs to analyze the information codes directly while receiving at the user terminal, the other is to transmit the information codes received by the user terminal to a remote terminal via a network for analysis and transmitted back to the user terminal afterwards. However, the user terminal must wait for an analyzing duration before it can know the values or meanings represented by the information codes no matter which one of the two ways is adopted.

According to the above descriptions, the user terminal cannot obtain various vehicle data of a vehicle simultaneously and efficiently under the OBD-series protocol architecture. Accordingly, an urgent need exists in the art to provide a solution that allows the user terminal to obtain vehicle data of the vehicle more efficiently under the OBD-series protocol architecture.

### SUMMARY

The primary objective of the present invention is to provide a vehicle data processing device and a vehicle data processing method thereof which allow a user terminal to obtain vehicle data of a vehicle more efficiently. The vehicle data processing device and the vehicle data processing method thereof of the present invention can obtain vehicle data provided by the vehicle in advance to form a data item menu, retrieve information codes of the vehicle data from the vehicle periodically and in advance according to various vehicle data items listed in the menu, and analyze the information codes of the vehicle data into readable data for storage. In other words, the vehicle data processing device and the vehicle data processing method thereof of the present invention have already stored the analyzed and readable vehicle data therein before the user terminal inquires the vehicle data.

Thereby, the vehicle data processing device and the vehicle data processing method thereof of the present invention can provide various analyzed and readable vehicle data to the user terminal simultaneously without being limited by the one-by-one question-and-answer transmission manner specified in the OBD-series protocols. Furthermore, the vehicle data processing device and the vehicle data processing method thereof of the present invention provide the vehicle data menu of the vehicle to the user terminal so that the user terminal checks vehicle data items to be inquired, and provide the analyzed and readable vehicle data to the user terminal either once or periodically as desired, thus eliminating the need of analyzing the vehicle data by the user terminal. In a word, the vehicle data processing device and the vehicle data processing method thereof of the present invention allow the user terminal to obtain vehicle data of the vehicle more efficiently.

To achieve the aforesaid objective, the present invention according to certain embodiments provides a vehicle data processing device. The vehicle data processing device comprises a vehicle network communication interface, a storage and a processor electrically connected to the vehicle network communication interface and the storage. The vehicle network communication interface is configured to communicate with a vehicle. The processor is configured to execute the following operations: obtaining vehicle data items of the vehicle via the vehicle network communication interface; creating a vehicle data menu according to the vehicle data item; transmitting an inquiry packet to the vehicle according to the vehicle data menu at a query time interval via the vehicle network communication interface; receiving a plurality of reply packets from the vehicle via the vehicle network communication interface, each of the reply packets corresponding to one of the inquiry packets; analyzing the reply packets to obtain a plurality of vehicle data of the vehicle; and storing the vehicle data into the storage.

In an embodiment of the present invention, the vehicle data processing device further comprises a user terminal communication interface electrically connected to the processor, and the user terminal communication interface is configured to communicate with a user terminal so as to provide the vehicle data to the user terminal.

To achieve the aforesaid objective, the present invention according to certain embodiments further provides a vehicle data processing method. The vehicle data processing method comprises the following steps of:

(a) enabling a processor to obtain vehicle data items of a vehicle via a vehicle network communication interface, wherein the processor is electrically connected to the vehicle network communication interface;

(b) enabling the processor to create a vehicle data menu according to the vehicle data items;

(c) enabling the processor to transmit an inquiry packet to the vehicle according to the vehicle data menu via the vehicle network communication interface at a query time interval;

(d) enabling the processor to receive a plurality of reply packets from the vehicle via the vehicle network communication interface, wherein each of the reply packets corresponds to one of the inquiry packets;

(e) enabling the processor to analyze the reply packets to obtain a plurality of vehicle data of the vehicle; and

(f) enabling the processor to store the vehicle data into a storage, wherein the processor is electrically connected to the storage.

In an embodiment of the present invention, the vehicle data processing method further comprises the following step of:

(g) enabling the processor to communicate with a user terminal via a user terminal communication interface so as to provide the vehicle data to the user terminal, wherein the processor is electrically connected to the user terminal communication interface.

The detailed technology and preferred embodiments implemented for the subject invention are described in the following paragraphs accompanying the appended drawings for people skilled in this field to well appreciate the features of the claimed invention. It is understood that the features mentioned hereinbefore and those to be commented on hereinafter may be used not only in the specified combinations, but also in other combinations or in isolation, without departing from the scope of the present invention.

### BRIEF DESCRIPTION OF THE DRAWINGS

FIG. 1 is a schematic view illustrating operations of a vehicle data processing device 1 according to a first embodiment of the present invention;

FIG. 2 is a diagram illustrating comparison between fields of a vehicle data menu 42 and a storage 15 according to the first embodiment of the present invention;

FIG. 3 is a flowchart diagram of a vehicle data processing method according to a second embodiment of the present invention; and

FIG. 4 is a detailed flowchart diagram of a step S37 of the vehicle data processing method according to the second embodiment of the present invention.

### DETAILED DESCRIPTION

The present invention can be explained with reference to the following example embodiments. However, these embodiments are not intended to limit the present invention to any specific example, embodiment, environments, applications or implementations described in these embodiments. Therefore, description of these embodiments is only for purpose of illustration rather than to limit the present invention. In the following embodiments and the attached drawings, elements not directly related to the present invention are omitted from depiction; and dimensional relationships among individual elements in the attached drawings are illustrated only for ease of understanding but not to limit the actual scale.

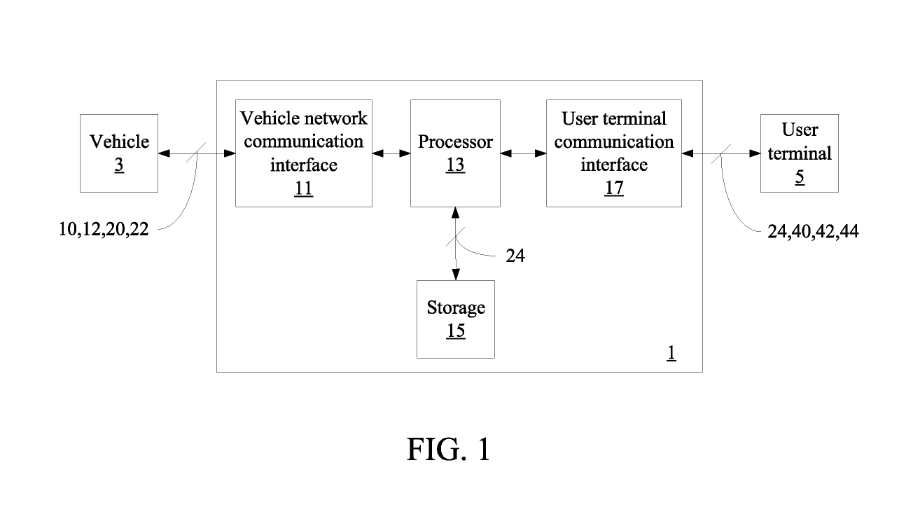

A first embodiment of the present invention is a vehicle data processing device. FIG. 1 is a schematic view illustrating operations of the vehicle data processing device 1 of this embodiment. As shown in FIG. 1, the vehicle data processing device 1 comprises a vehicle network communication interface 11, a processor 13, a storage 15 and a user terminal communication interface 17. The processor 13 is electrically connected to the vehicle network communication interface 11, the storage 15 and the user terminal communication interface 17. The vehicle data processing device 1 can communicate with a vehicle 3 via the vehicle network communication interface 11, and communicate with a user terminal 5 via the user terminal communication interface 17.

The vehicle 3 is any vehicle of any type that conforms to the OBD protocol or the OBD2 protocol (collectively termed as the OBD-series protocols hereinafter), and the vehicle network communication interface 11 can communicate with the vehicle 3 according to the OBD-series protocols. Preferably, the vehicle network communication interface 11 may be connected with the vehicle 3 via a controller area network bus; however, this is not intended to limit the implementations of the present invention.

After the vehicle network communication interface 11 is connected with the vehicle 3, the processor 13 can obtain vehicle data items of the vehicle 3 via the vehicle network communication interface 11. For example, as shown in FIG. 1, the processor 13 transmits an item inquiry signal 10 (which may comprise a program code, e.g., 0100 or 0120) to the vehicle 3 in advance via the vehicle network communication interface 11, and the vehicle 3 returns an item reply signal 12 to the vehicle network communication interface 11 in response to the item inquiry signal 10. In this way, the processor 13 can obtain the information of the item reply signal 12, the vehicle data items (not shown) provided by the vehicle 3, via the vehicle network communication interface 11 to know how many vehicle data items supported by the vehicle 3.

After obtaining the vehicle data items provided by the vehicle 3, the processor 13 can create a vehicle data menu 42 according to the vehicle data items. Then, according to the vehicle data items listed in the vehicle data menu 42, the processor 13 can transmit an inquiry packet 20 to the vehicle 3 at a query time interval via the vehicle network communication interface 11 as to inquire the vehicle 3 for the various vehicle data. Then, the processor 13 can receive a plurality of reply packets 22 from the vehicle 3 via the vehicle network communication interface 11. Each of the reply packets 22 corresponds to one of the inquiry packets 20.

Specifically, the OBD-series protocols specify that the vehicle data of the vehicle 3 can only be obtained in the one-by-one question-and-answer manner. Therefore, each time the processor 13 transmits an inquiry packet 20 to the vehicle 3 according to the vehicle data items listed in the vehicle data menu 42 via the vehicle network communication interface 11, the vehicle 3 will return the vehicle data inquired by the inquiry packet 20 by transmitting a reply packet 22 to the vehicle network communication interface 11.

For the reply packets 22 received, each time the vehicle network communication interface 11 receives a reply packet 22 from the vehicle 3, the processor 13 will analyze the reply packet 22 according to the OBD-series protocols to obtain a vehicle datum 24 of the vehicle 3, and store the vehicle datum 24 into the storage 15. As the reply packets 22 received from the vehicle 3 have been analyzed by the processor 13 into the readable vehicle data 24, the vehicle data 24 can be readily understood by the user terminal.

For example, it is supposed that the processor 13 transmits an inquiry packet 20 to the vehicle 3 via the vehicle network communication interface 11 to inquire current vehicle speed information (e.g., 60 kmh) of the vehicle 3. Upon receiving the inquiry packet 20, the vehicle 3 encodes the vehicle speed information into a string of information codes (e.g., 01010111) according to the OBD-series protocols, and transmits the information codes to the vehicle network communication interface 11 through a reply packet 22. Then, the processor 13 analyzes the reply packet 22 to obtain a vehicle datum 24 (i.e., 60 kmh), and stores the vehicle datum 24 into the storage 15.

As described above, the processor 13 transmits an inquiry packet 20 to the vehicle 3 at a query time interval via the vehicle network communication interface 11, and the query time interval per se can be adjusted according to the vehicle data of different properties of the vehicle 3. Likewise, the vehicle data 24 stored in the storage 15 are updated according to different query time intervals.

For example, if the vehicle data 24 (i.e., the vehicle data to be inquired from the vehicle 3) are the data that rapidly changes as time, such as a vehicle speed or a rotation speed, then the query time interval can be set as a relatively short time interval (e.g., 10 milliseconds) so as to adapt to the rapid changes. However, if the vehicle data 24, the vehicle data to be inquired from the vehicle 3, are the data that slightly change as time, such as an engine coolant temperature or a control module (CM) voltage, then the query time interval can be set as a relatively long time interval (e.g., 5 minutes). Thus, not only congestions of the vehicle network caused by excessive inquiries made to the ECU of the vehicle can be reduced, but also the latest information of the vehicle data 24 of the vehicle 3 stored in the storage 15 are allowed to be maintained.

The aforesaid operations of the vehicle network communication interface 11, the storage 15 and the processor 13 are carried out automatically and periodically in advance. More specifically, before the user terminal 5 inquires the vehicle 3 about the vehicle data, the vehicle data processing device 1 has already had the vehicle data of the vehicle 3 stored therein. Therefore, when the user terminal 5 inquires the vehicle 3 about the vehicle data via the vehicle data processing device 1, the vehicle data processing device 1 can provide the vehicle data by retrieving the vehicle data from the storage 15 immediately. In other words, the vehicle data processing device 1 works without following such procedures as making inquiries to the vehicle 3 and receiving replies from the vehicle 3 in the one-by-one question-and-answer manner according to an instruction given by the user terminal 5. In addition, the vehicle data 24 provided by the vehicle data processing device 1 to the user terminal 5 are analyzed and readable vehicle data so that the user terminal can know the vehicle data of the vehicle directly according to the vehicle data 24 without the need of analysis by the user terminal 5.

Hereinafter, the operational relationships between the vehicle data processing device 1 and the user terminal will be further described. However, the operational relationships described below are not intended to limit the implementations of the present invention. The user terminal communication interface 17 may be connected with the user terminal 5 in a wired or wireless way, for example but not limited to, through transmission lines of various specifications, USB connectors, the Bluetooth, infrared rays, optical fibers and so on. Additionally, the user terminal communication interface 17 may be connected with the user terminal 5 by using various conventional transmission networks as transmission media, for example but not limited to, transmission control protocol/Internet protocol (TCP/IP) networks. The user terminal communication interface 17 can transmit the various vehicle data 24 stored in the storage 15 to the user terminal 5 according to various conventional data transmission protocols, for example but not limited to, the user data protocol (UDP).

The user terminal 5 can request the necessary vehicle data of the vehicle 3 from the vehicle data processing device 1 by transmitting different user instructions. Preferably, the user terminal 5 can firstly, through a user instruction, request the vehicle data processing device 1 to provide the vehicle data menu 42 associated with the vehicle data of the vehicle 3. This can effectively avoid that the user terminal 5 requests the vehicle data processing device 1 for the vehicle data 24 that are not provided by the vehicle 3, which would cause a waste of the communication bandwidth between the vehicle data processing device 1 and the user terminal 5.

As described above, the processor 13 can obtain the vehicle data of the vehicle 3 through the item reply signal 12, and create a corresponding vehicle data menu 42 according to the vehicle data. Then, after a user instruction 40 of providing the vehicle data menu 42 is received by the processor 13 from the user terminal 5 via the user terminal communication interface 17, the processor 13 can transmit the vehicle data menu 42 to the user terminal 5 via the user terminal communication interface 17.

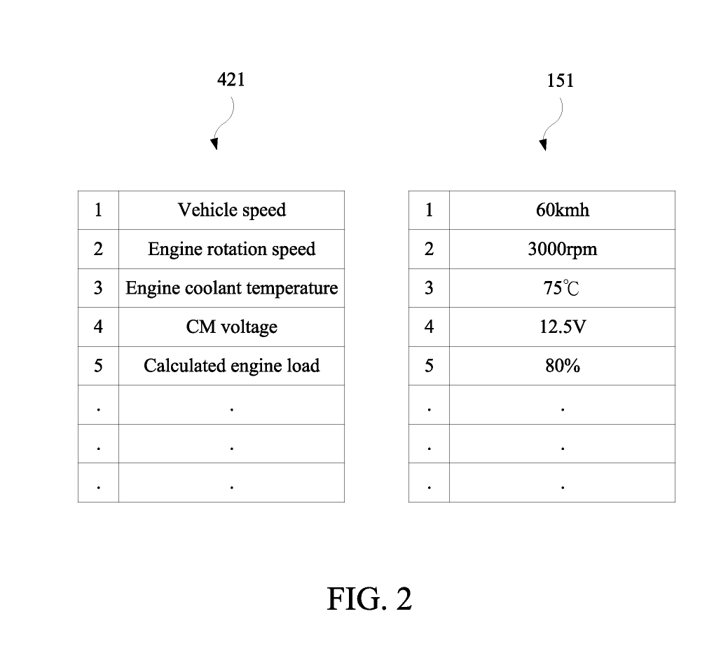

FIG. 2 is a diagram illustrating comparison between fields of the vehicle data menu 42 and the storage 15 of this embodiment. As shown in FIG. 2, the vehicle data menu 42 may comprise a plurality of menu fields 421, which correspond to the items of the vehicle data provided by the vehicle 3. The storage 15 may also comprise a plurality of storage fields 151, which store the vehicle data 24 corresponding to the menu fields 421 of the vehicle data menu 42.

After receiving the vehicle data menu 42, the user terminal 5 can select one or more vehicle data 24 from the menu fields 421 of the vehicle data menu 42, and transmit a selection signal 44 corresponding to the vehicle data menu 42 to the vehicle data processing device 1 to request for the vehicle data 24 selected by the user terminal 5. On the other hand, the processor 13 can receive the selection signal 44 corresponding to the vehicle data menu 42 from the user terminal 5 via the user terminal communication interface 17 and, according to the selection signal 44, know the items of the vehicle data 24 requested by the user terminal 5.

After receiving the selection signal 44, the processor 13 can transmit the vehicle data 24 stored in the storage 15 to the user terminal 5 via the user terminal communication interface 17 according to the selection signal 44. For example, supposing that the user terminal only selects the second menu field (i.e., the engine rotation speed), then the processor 13 will transmit the vehicle datum 24 (i.e., 3000 rpm) stored in the second storage field of the storage 15 to the user terminal 5 via the user terminal communication interface 17 according to the selection signal 44.

Supposing that the user terminal selects the first menu field, the third menu field and the fourth menu field (i.e., the vehicle speed, the engine coolant temperature and the CM voltage), then the processor 13 will transmit the vehicle data 24 (i.e., 60 kmh, 75° C. and 12.5V) stored in the first storage field, the third storage field and the fourth storage field of the storage 15 to the user terminal 5 via the user terminal communication interface 17 according to the selection signal 44.

It shall be appreciated that, because the menu fields 421 of the vehicle data menu 42 correspond to the storage fields 151 of the storage 15, the processor 13 of the vehicle data processing device 1 can find the corresponding vehicle data 24 from the storage fields 151 of the storage 15 immediately upon receiving the selection signal 44. Therefore, the time of transmitting the vehicle data 24 to the user terminal 5 can be effectively reduced on the whole.

Optionally, if the user terminal 5 needs to know the vehicle data 24 periodically, then the user terminal 5 can further inform the vehicle data processing device 1 of the vehicle data 24 through the selection signal 44. Thus, the processor 13 can periodically transmit one or more of the vehicle data 24 stored in the storage 15 to the user terminal 5 at a waiting time interval via the user terminal communication interface 17 according to the selection signal 44.

In a word, the processor 13 can transmit one or more of the vehicle data 24 to the user terminal 5 either once or periodically via the user terminal communication interface 17 according to the needs of the user terminal 5. For example, supposing that the user terminal 5 desires to obtain the vehicle data 24 at a waiting time interval (e.g., 1 second, 5 minutes, 2 hours etc.), then the processor 13 can know the waiting time interval according to the selection signal 44 and transmit the vehicle data 24 stored in the storage 15 to the user terminal 5 at a waiting time interval via the user terminal communication interface 17. In other embodiments, the user terminal 5 may also, through the selection signal 44, inform the vehicle data processing device 1 that the vehicle data 24 only need to be provided once.

Furthermore, when the user terminal 5 desires to stop receiving the vehicle data 24, the user terminal 5 can transmit a stop instruction (not shown) to the processor 13 at any time via the user terminal communication interface 17. Then, the processor 13 will stop transmitting the vehicle data 24 to the user terminal 5 according to the stop instruction.

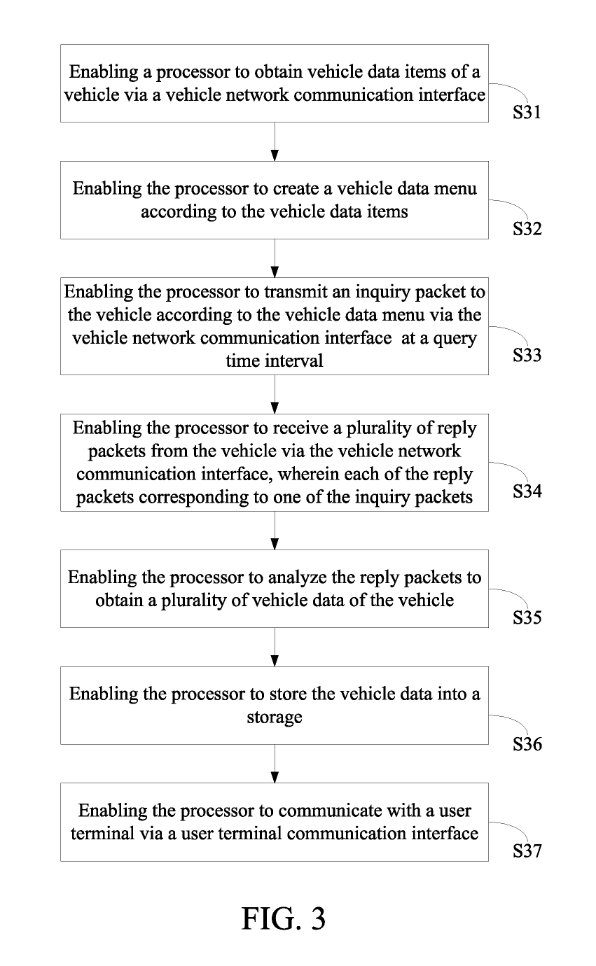

A second embodiment of the present invention is a vehicle data processing method. FIG. 3 is a flowchart diagram of the vehicle data processing method of this embodiment. The vehicle data processing method of this embodiment can be used in the vehicle data processing device 1 as described in the first embodiment. Therefore, a vehicle network communication interface, a storage, a processor and a user terminal communication interface described later in this embodiment can be substantially viewed as the vehicle network communication interface 11, the storage 15, the processor 13 and the user terminal communication interface 17 described in the first embodiment, and the processor is electrically connected to the vehicle network communication interface, the storage and the user terminal communication interface.

As shown in FIG. 3, step S31 is executed to enable a processor to obtain vehicle data items of a vehicle via a vehicle network communication interface. Step S32 is executed to enable the processor to create a vehicle data menu according to the vehicle data items. Step S33 is executed to enable the processor to transmit an inquiry packet to the vehicle according to the vehicle data menu via the vehicle network communication interface at a query time interval. Step S34 is executed to enable the processor to receive a plurality of reply packets from the vehicle via the vehicle network communication interface, wherein each of the reply packets corresponding to one of the inquiry packets. Step S35 is executed to enable the processor to analyze the reply packets to obtain a plurality of vehicle data of the vehicle. Step S36 is executed to enable the processor to store the vehicle data into a storage.

Optionally, the vehicle data processing method of this embodiment further comprises a step S37. Step S37 is executed to enable the processor to communicate with a user terminal via a user terminal communication interface so as to provide the vehicle data to the user terminal. In other embodiments, the step S37 may further comprise a step S41, a step S42, a step S43 and a step S44.

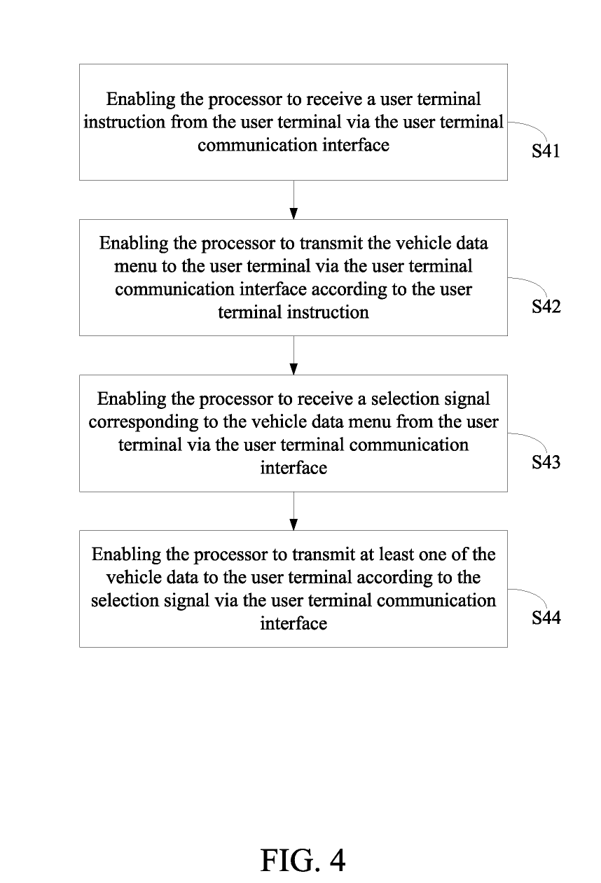

As shown in FIG. 4, Step S41 is executed to enable the processor to receive a user terminal instruction from the user terminal via the user terminal communication interface. Step S42 is executed to enable the processor to transmit the vehicle data menu to the user terminal via the user terminal communication interface according to the user terminal instruction. The vehicle data menu may comprise a plurality of menu fields so that the user terminal selects at least one of the vehicle data from the vehicle data menu. Step S43 is executed to enable the processor to receive a selection signal corresponding to the vehicle data menu from the user terminal via the user terminal communication interface. Step S44 is executed to enable the processor to transmit at least one of the vehicle data to the user terminal according to the selection signal via the user terminal communication interface. The processor may transmit at least one of the vehicle data to the user terminal either once or at a waiting time interval.

In addition to the aforesaid steps, the vehicle data processing method of this embodiment can also execute all the operations of the vehicle data processing device 1 set forth in the first embodiment and accomplish all the corresponding functions. How the vehicle data processing method of this embodiment executes these operations and accomplishes these functions can be readily appreciated by those of ordinary skill in the art based on the explanation of the first embodiment, and thus will not be further described herein.

According to the above descriptions, the present invention provides a vehicle data processing device and a vehicle data processing method thereof. The vehicle data processing device and the vehicle data processing method thereof of the present invention can obtain vehicle data provided by a vehicle in advance to form a data item menu, retrieve information codes of the vehicle data from the vehicle periodically and in advance according to various vehicle data items listed in the menu, and analyze the information codes of the vehicle data into readable data for storage. In other words, the vehicle data processing device and the vehicle data processing method thereof of the present invention have already stored the analyzed and readable vehicle data therein before the user terminal inquires the vehicle data of the vehicle.

Thereby, the vehicle data processing device and the vehicle data processing method thereof of the present invention can provide various analyzed and readable vehicle data to the user terminal simultaneously without being limited by the one-by-one question-and-answer transmission manner specified in the OBD-series protocols. Furthermore, the vehicle data processing device and the vehicle data processing method thereof of the present invention provide the vehicle data menu of the vehicle to the user terminal so that the user terminal checks vehicle data items to be inquired, and provide the analyzed and readable vehicle data to the user terminal either once or periodically as desired, thus eliminating the need of analyzing the vehicle data by the user terminal. In a word, the vehicle data processing device and the vehicle data processing method thereof of the present invention allow the user terminal to obtain vehicle data of the vehicle more efficiently.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

1. A vehicle data processing device, comprising:
a vehicle network communication interface, being configured to communicate with a vehicle based on an On-Board Diagnostics series protocol;
a storage; and
a processor electrically connected to the vehicle network communication interface and the storage, and configured to, before a user terminal inquires vehicle data of the vehicle, obtain vehicle data items of the vehicle network communication interface to create a vehicle data menu, periodically transmit an inquiry packet to the vehicle according to the vehicle data menu via the vehicle network communication interface at a query time interval, receive a plurality of reply packets corresponding to the inquiry packets from the vehicle via the vehicle network communication interface, analyze the reply packets to obtain the vehicle data of the vehicle, and store the vehicle data into the storage.

2. The vehicle data processing device as claimed in claim 1, further comprising a user terminal communication interface electrically connected to the processor, wherein the user terminal communication interface is configured to communicate with the user terminal so as to provide the vehicle data to the user terminal.

3. The vehicle data processing device as claimed in claim 2, wherein the vehicle data menu comprises a plurality of menu fields, and the processor is further configured to receive a user terminal instruction from the user terminal via the user terminal communication interface, transmit the vehicle data menu to the user terminal via the user terminal communication interface according to the user terminal instruction so that the user terminal selects at least one of the vehicle data from the vehicle data menu, receive a selection signal corresponding to the vehicle data menu from the user terminal via the user terminal communication interface, and transmit at least one of the vehicle data to the user terminal according to the selection signal via the user terminal communication interface.

4. The vehicle data processing device as claimed in claim 3, wherein the processor is configured to transmit at least one of the vehicle data to the user terminal according to the selection signal via the user terminal communication interface at a waiting time interval.

5. The vehicle data processing device as claimed in claim 3, wherein the selection signal comprises a plurality of the vehicle data, and the processor transmits the plurality of the vehicle data to the user terminal according to the selection signal via the user terminal communication interface.

6. The vehicle data processing device as claimed in claim 3, wherein the storage comprises a plurality of storage fields, which are configured to store the vehicle data corresponding to the menu fields of the vehicle data menu.

7. A vehicle data processing method for use in a vehicle data processing device, the vehicle data processing device communicate with a vehicle based on an On-Board Diagnostics series protocol, the vehicle data processing method comprising the following steps of:
(a) enabling a processor to obtain vehicle data items of a vehicle via a vehicle network communication interface before a user terminal inquires vehicle data of the vehicle, wherein the processor is electrically connected to the vehicle network communication interface;
(b) enabling the processor to create a vehicle data menu according to the vehicle data items before the user terminal inquires the vehicle data of the vehicle;
(c) enabling the processor to periodically transmit an inquiry packet to the vehicle according to the vehicle data menu via the vehicle network communication interface at a query time interval before the user terminal inquires the vehicle data of the vehicle;
(d) enabling the processor to receive a plurality of reply packets corresponding to the inquiry packets from the vehicle via the vehicle network communication interface before the user terminal inquires the vehicle data of the vehicle;
(e) enabling the processor to analyze the reply packets to obtain the vehicle data of the vehicle before the user terminal inquires the vehicle data of the vehicle; and
(f) enabling the processor to store the vehicle data into a storage before the user terminal inquires the vehicle data of the vehicle, wherein the processor is electrically connected to the storage.

8. The vehicle data processing method as claimed in claim 7, further comprising the following step of:
(g) enabling the processor to communicate with the user terminal via a user terminal communication interface so as to provide the vehicle data to the user terminal, wherein the processor is electrically connected to the user terminal communication interface.

9. The vehicle data processing method as claimed in claim 8, wherein the step (g) further comprises the following steps of:
(g1) enabling the processor to receive a user terminal instruction from the user terminal via the user terminal communication interface;
(g2) enabling the processor to transmit the vehicle data menu to the user terminal via the user terminal communication interface according to the user terminal instruction, wherein the vehicle data menu comprises a plurality of menu fields so that the user terminal selects at least one of the vehicle data from the vehicle data menu;
(g3) enabling the processor to receive a selection signal from the user terminal via the user terminal communication interface, wherein the selection signal corresponds to the vehicle data menu; and
(g4) enabling the processor to transmit at least one of the vehicle data to the user terminal according to the selection signal via the user terminal communication interface.

10. The vehicle data processing method as claimed in claim 9, wherein the step (g4) is as follows:
(g41) enabling the processor to transmit at least one of the vehicle data to the user terminal according to the selection signal via the user terminal communication interface at a waiting time interval.

11. The vehicle data processing method as claimed in claim 9, wherein the selection signal comprises a plurality of the vehicle data, and the processor transmits the plurality of the vehicle data to the user terminal according to the selection signal via the user terminal communication interface.

12. The vehicle data processing method as claimed in claim 9, wherein the storage comprises a plurality of storage fields, which are configured to store the vehicle data corresponding to the menu fields of the vehicle data menu.
